(19) United States
(12) Patent Application Publication
(10) Pub. No.: US 2026/0086436 A1
(43) Pub. Date: Mar. 26, 2026

(54) WEARABLE ELECTRONIC DEVICE FOR ADJUSTING LUMINANCE OF LIGHT, OPERATING METHOD THEREFOR, AND RECORDING MEDIUM

(71) Applicant: Samsung Electronics Co., Ltd., Suwon-si (KR)

(72) Inventors: Joungmin CHO, Suwon-si (KR); Junhee KIM, Suwon-si (KR); Joonyoung SONG, Suwon-si (KR)

(21) Appl. No.: 19/408,771

(22) Filed: Dec. 4, 2025

Related U.S. Application Data
(63) Continuation of application No. PCT/KR2024/009589, filed on Jul. 5, 2024.

(30) Foreign Application Priority Data
Jul. 17, 2023 (KR) 10-2023-0092356
Aug. 14, 2023 (KR) 10-2023-0106175

(51) Int. Cl. G03B 15/05; G06F 3/01; G06T 7/521

(52) U.S. Cl. CPC G03B 15/05; G06F 3/013; G06T 7/521; G06T 2207/30196

(57) ABSTRACT

A wearable electronic device may include: a camera; a display including a plurality of pixels; a lens module including at least one lens and a plurality of light emitting elements; a processor(s) comprising processing circuitry; and a memory storing instructions, wherein the instructions may be configured, when executed by the processor, cause the wearable electronic device to: when the wearable electronic device is worn by a user, output a plurality of invisible lights to the eyes of the user through the plurality of light emitting elements; identify, through the camera, a plurality of points formed on the eyes by the plurality of invisible lights; identify a first distance between the lens and the eyes on the basis of a pattern of the plurality of points; and adjust luminance of light output from the plurality of pixels on the basis of the first distance and the positions of the plurality of pixels. Various other embodiments are possible.

### CROSS-REFERENCE TO RELATED APPLICATION(S)

This application is a continuation application of an International application No. PCT/KR2024/009589, filed on Jul. 5, 2024, which is based on and claims the benefit of a Korean patent application number 10-2023-0092356, filed on Jul. 17, 2023, in the Korean Intellectual Property Office, and of a Korean patent application number 10-2023-0106175, filed on Aug. 14, 2023, in the Korean Intellectual Property Office, the disclosures of each of which are hereby incorporated by reference herein in their entireties.

### BACKGROUND

### 1. Field

Certain example embodiments may relate to a wearable electronic device for adjusting the luminance of light, an operating method thereof, and/or a recording medium.

### 2. Description of Related Art

The number of services and additional functions provided through wearable electronic devices such as video see-through (VST) devices is gradually increasing. To enhance the utility of these electronic devices and satisfy the diverse needs of users, communication service providers and electronic device manufacturers are competitively developing electronic devices to provide various functions and seek differentiation from other companies. Accordingly, the functions provided through wearable electronic devices are becoming increasingly advanced.

A VST device, while being worn on the user's body, may provide the user with a realistic experience by displaying virtual images. The VST device may replace the usability of a smartphone in various fields such as game entertainment, education, and social networking services (SNS). A user may be provided with content similar to reality through the VST device, and may feel as if staying in a virtual world through interaction.

The information described above may be provided as related art for aiding in the understanding of the disclosure. No assertion or determination is made as to whether any of the above constitutes prior art with respect to the disclosure.

### SUMMARY

According to an example embodiment, a wearable electronic device may include a camera, a display including a plurality of pixels, a lens module including at least one lens and a plurality of light emitting elements, a processor(s) comprising processing circuitry, and memory configured to store instructions.

According to an example embodiment, when the wearable electronic device is identified to be worn by a user (including worn by a user), the wearable electronic device may output a plurality of invisible light to an eye of the user via the plurality of light emitting elements.

According to an example embodiment, the wearable electronic device may identify a plurality of dots on which the plurality of invisible light are focused on the eye through the camera.

According to an example embodiment, the wearable electronic device 301 may identify a first distance between the at least one lens and the eye of the user, based on a pattern of the plurality of dots.

According to an example embodiment, the wearable electronic device may adjust luminance of light output from the plurality of pixels, based on the first distance and a position of the plurality of pixels.

According to an example embodiment, a method of operating the wearable electronic device may include outputting, when the wearable electronic device is identified to be worn by a user, a plurality of invisible light to an eye of the user via the plurality of light emitting elements.

According to an example embodiment, the method of operating the wearable electronic device may include identifying a plurality of dots on which the plurality of invisible light are focused on the eye through the camera.

According to an example embodiment, the method of operating the wearable electronic device may include identifying a first distance between the at least one lens and the eye, based on a pattern of the plurality of dots.

According to an example embodiment, the method of operating the wearable electronic device may include adjusting luminance of light output from the plurality of pixels, based on the first distance and a position of the plurality of pixels.

According to an example embodiment, a non-transitory recording medium may store at least one instruction that, when executed, causes the wearable electronic device to, when the wearable electronic device is identified to be worn by a user, output a plurality of invisible light to an eye of the user via the plurality of light emitting elements.

According to an example embodiment, the non-transitory recording medium may store at least one instruction that, when executed, causes the wearable electronic device to identify a plurality of dots on which the plurality of invisible light are focused on the eye through the camera.

According to an example embodiment, the non-transitory recording medium may store at least one instruction that, when executed, causes the wearable electronic device to identify a first distance between the at least one lens and the eye, based on a pattern of the plurality of dots.

According to an example embodiment, the non-transitory recording medium may store at least one instruction that, when executed, causes the wearable electronic device to adjust luminance of light output from the plurality of pixels, based on the first distance and a position of the plurality of pixels.

### BRIEF DESCRIPTION OF THE DRAWINGS

FIG. 1 is a block diagram of an electronic device in a network environment according to various example embodiments.

FIGS. 2A and 2B illustrate a front view and a rear view of a wearable electronic device according to an example embodiment, respectively.

FIG. 3 is a schematic block diagram of a wearable electronic device according to an example embodiment.

FIG. 4 illustrates a rear view of a wearable electronic device according to an example embodiment.

FIG. 5A illustrates a portion of a wearable electronic device worn by a user according to an example embodiment.

FIG. 5B illustrates an operation of identifying a distance between one eye of a user and at least one first lens through a dial when a wearable electronic device is worn by the user according to an example embodiment.

FIG. 6 is a flowchart for illustrating an operation of identifying a first distance between at least one first lens and an eye by a wearable electronic device according to an example embodiment.

FIGS. 7(a)-(d) illustrate an operation of identifying, based on a pattern of a plurality of dots, a distance between at least one first lens and an eye by a wearable electronic device according to an example embodiment.

FIG. 8 illustrates at least one first lens and a first display according to an example embodiment.

FIGS. 9(a)-(b) illustrate graphs related to the luminance of light output from a first display and the luminance of the light transmitted through at least one first lens, when the luminance of light output from the first display is not adjusted by a wearable electronic device according to an example embodiment.

FIGS. 10(a)-(b) illustrate a graph related to the adjusted luminance of light output from a first display and the luminance of the light transmitted through at least one first lens according to an example embodiment.

FIGS. 11(a)-(b) illustrate a graph related to the adjusted luminance of light output from a first display and the luminance of the light transmitted through at least one first lens according to an example embodiment.

### DETAILED DESCRIPTION

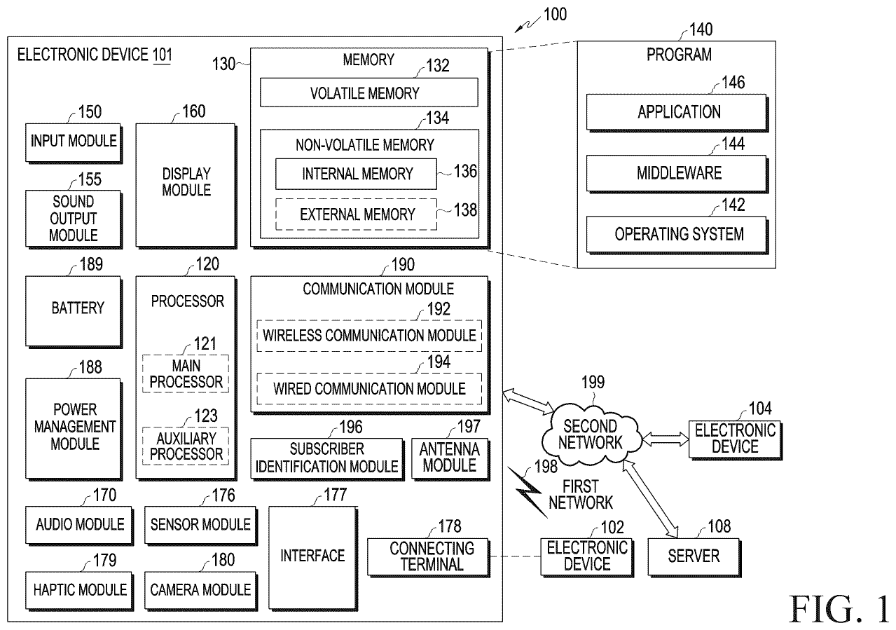

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

According to an embodiment, each of the external electronic devices 102 and 104 may be implemented as the same type or a different type of device as the electronic device 101. According to an embodiment, the external electronic device 102 may be implemented in various forms of devices, such as a case device configured to accommodate and charge the electronic device 101.

According to an embodiment, at least one of operations executed in the electronic device 101 may be executed by one or more of the external electronic devices 102, 104, or 108. For example, when the electronic device 101 needs to perform a function or service automatically, or in response to a request from a user or another device different from the electronic device 101, the electronic device 101 may request one or more of the external electronic devices 102, 104, or 108 to perform at least a part of the function or service. One or more of the external electronic devices 102, 104, or 108 that have received the request may execute at least a part of the requested function or service and/or an additional function or service related to the request, and transmit a result of the execution to the electronic device 101. The electronic device 101 may provide the result as at least a part of a response to the request. For example, one or more of the external electronic devices 102, 104, or 108 may render content data and then transmit the rendered content data to the electronic device 101, and the electronic device 101 may output the content data to a display module 160. In this case, when user movement is detected through an inertial measurement unit (IMU) sensor included in the electronic device 101, the electronic device 101 may correct the content data received from one or more of the external electronic devices 102, 104, or 108, based on information of the movement, and output the corrected content data to the display module 160. Alternatively, the electronic device 101 may transmit the information of the movement to one or more of the external electronic devices 102, 104, or 108 and request the external electronic device(s) to render the content data, based on the information of the movement.

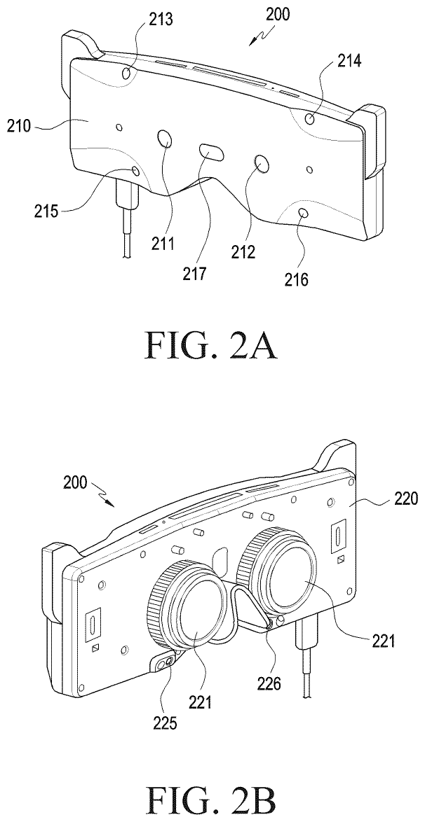

FIGS. 2A and 2B illustrate a front view and a rear view of a wearable electronic device according to an embodiment, respectively.

Referring to FIGS. 2A and 2B, in an embodiment, camera modules 211, 212, 213, 214, 215, 216 and/or a depth sensor 217 for acquiring information related to the surrounding environment of a wearable electronic device 200 may be disposed on a first surface 210 of a housing.

In an embodiment, the camera modules 211, 212 may acquire images related to the surrounding environment of the wearable electronic device.

In another embodiment, the camera modules 213, 214, 215, 216 may acquire images while the wearable electronic device is being worn by a user. The camera modules 213, 214, 215, 216 may be used for hand detection, tracking, and gesture recognition of a user (e.g., hand movements). The camera modules 213, 214, 215, 216 may be used for three degree of freedom (3DoF) and 6DoF head tracking, position (spatial/environmental) recognition, and/or movement recognition. In an embodiment, the camera modules 211, 212 may also be used for hand detection, tracking, and gesture recognition of a user.

In an embodiment, the depth sensor 217 may be configured to transmit a signal and receive a signal reflected from a subject, and may be used to identify a distance to an object, such as by a time-of-flight (TOF) method. The camera modules 213, 214, 215, 216 may be used to identify a distance to an object in place of or in addition to the depth sensor 217.

According to an embodiment, a second surface 220 of the housing may include facial-recognition camera modules 225, 226 and/or a display 221 (and/or a lens).

In an embodiment, the facial-recognition camera modules 225, 226 adjacent to the display may be used to recognize a user's face or to recognize and/or track the user's eyes.

In an embodiment, the display 221 (and/or a lens) may be disposed on the second surface 220 of the wearable electronic device 200. In another embodiment, the wearable electronic device 200 may not include the camera modules 215, 216 among the plurality of camera modules 213, 214, 215, 216.

As described above, the wearable electronic device 200 according to an embodiment may have a form factor configured to be worn on a user's head. The wearable electronic device 200 may further include a strap and/or a wearing member for being fixed to a body part of the user. While being worn on the user's head, the wearable electronic device 200 may provide a user experience based on augmented reality, virtual reality, and/or mixed reality.

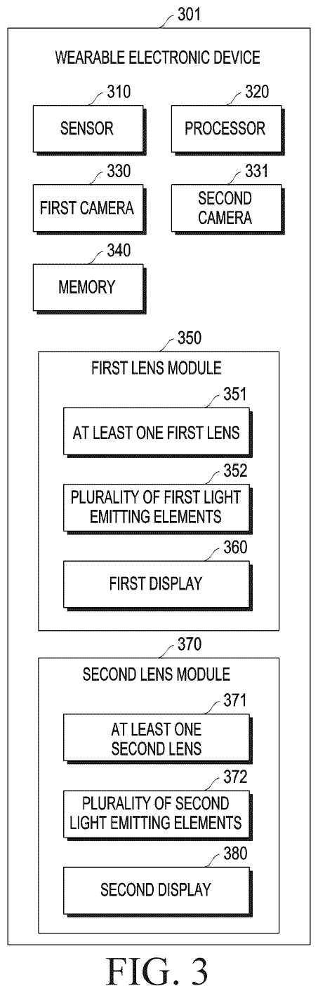

FIG. 3 is a schematic block diagram of a wearable electronic device according to an embodiment.

Referring to FIG. 3, according to an embodiment, a wearable electronic device 301 may be implemented identically or similarly to the electronic device 101 of FIG. 1 and the wearable electronic device 200 of FIGS. 2A and 2B. According to an embodiment, the wearable electronic device 301 may be implemented as a video see-through (VST) device.

According to an embodiment, the wearable electronic device 301 may include a sensor 310, a processor 320, a first camera 330, a second camera 331, memory 340, a first lens module 350, a second lens module 370, a first display 360, and a second display 380.

According to an embodiment, the processor 320 may control the overall operation of the wearable electronic device 301. For example, the processor 320 may be implemented identically or similarly to the processor 120 of FIG. 1.

According to an embodiment, the first camera 330 and the second camera 331 may be implemented identically or similarly to the facial-recognition camera modules 225, 226 of FIG. 2B. According to an embodiment, the first display 360 and the second display 380 may be implemented identically or similarly to the display 221 of FIG. 2B.

According to an embodiment, the processor 320 may identify, through the sensor 310 (e.g., the sensor module 176 of FIG. 1), whether the wearable electronic device 301 is worn by a user. For example, the sensor 310 may include a proximity sensor.

According to an embodiment, when the wearable electronic device 301 is worn by a user, the first lens module 350 may be disposed at a position corresponding to one eye of the user, and the second lens module 370 may be disposed at a position corresponding to the other eye of the user.

According to an embodiment, the first lens module 350 may include at least one first lens 351, a plurality of first light emitting elements 352, and a first display 360. According to an embodiment, the second lens module 370 may include at least one second lens 371, a plurality of second light emitting elements 372, and a second display 380.

According to an embodiment, the description of the first lens module 350 and the first display 360 may equally apply to the second lens module 370 and the second display 380. However, for convenience of explanation, the following description will focus on the first lens module 350 and the first display 360 corresponding to one eye of the user.

According to an embodiment, the plurality of first light emitting elements 352 may be disposed on an edge portion of a housing of the first lens module 350 and may be exposed to the outside of the housing of the first lens module 350. Depending on the implementation, the plurality of first light emitting elements 352 may be included in the first display 360. Depending on the implementation, the plurality of first light emitting elements 352 may not be included in the first lens module 350 and the first display 360 but may be disposed on a rear surface of the wearable electronic device 301.

According to an embodiment, at least one first lens 351 may be implemented as a lens assembly including a plurality of lenses. For example, the plurality of lenses may be stacked and arranged on each other. According to an embodiment, at least one first lens 351 may be implemented in a pancake-lens structure. According to an embodiment, the at least one first lens 351 may also be implemented as a single lens.

According to an embodiment, the first lens module 350 and the first display 360 may be implemented as a single module.

According to another embodiment, the first display 360 may be implemented as a module separate from the first lens module 350. The first display 360 may be disposed under the first lens module 350.

According to an embodiment, the size of the first display 360 may be larger than that of the at least one first lens 351. According to an embodiment, the first display 360 may have a rectangular shape, and at least one first lens 351 may have a circular shape. In an embodiment, the size of the first display 360 may be equal to that of at least one first lens 351. In an embodiment, the first display 360 may have a circular shape. However, these are merely examples, and the size or shape of the first display 360 and the shape of at least one first lens 351 are not limited thereto.

According to an embodiment, the first display 360 may be implemented as an organic light emitting diode (OLED) or a light emitting diode (LED) display. According to an embodiment, the first display 360 may include a plurality of pixels. For example, the plurality of pixels may include red (R), green (G), blue (B), and/or white (W) pixels. In an example, the plurality of pixels may include a plurality of unit pixels. A unit pixel may include R, G, and B pixels. In another example, a unit pixel may include R, G, B, and W pixels. In an example, a unit pixel may include at least one of R, G, B, or W pixels.

According to an embodiment, the processor 320 may output a plurality of invisible light to one eye of a user via the plurality of first light emitting elements 352. According to an embodiment, the plurality of first light emitting elements 352 may emit light in an infrared (IR) wavelength band.

According to an embodiment, the processor 320 may identify a plurality of dots on which a plurality of invisible light are focused on one eye of the user through the first camera 330. According to an embodiment, the processor 320 may acquire an image of one eye of the user via the first camera 330. According to an embodiment, the processor 320 may identify a pattern of the plurality of dots from the image. For example, the pattern of the plurality of dots may indicate an arrangement state of the plurality of dots.

According to an embodiment, the processor 320 may identify a first distance between at least one first lens 351 and one eye of the user, based on the pattern of the plurality of dots. According to an embodiment, the first distance may indicate an eye relief (ER) distance between the lens and the eye.

According to an embodiment, the first distance may refer to a linear distance between the pupil of one eye and at least one first lens 351. According to an embodiment, when the at least one first lens 351 is implemented as a lens assembly including a plurality of lenses, the first distance may refer to a linear distance between the pupil of one eye of a user and an outermost lens among the plurality of lenses disposed on the first display 360.

According to an embodiment, the processor 320 may identify a second distance between the plurality of dots. According to an embodiment, the second distance between the plurality of dots may refer to a distance between two adjacent dots. According to an embodiment, the processor 320 may identify the first distance, based on the second distance between the plurality of dots. For example, when the plurality of dots are more than two, the second distance between the plurality of dots may include an average value of distances between adjacent dots, a minimum value among the distances between adjacent dots, or a maximum value among the distances between adjacent dots.

According to an embodiment, the processor 320 may identify the first distance, based on the second distance between the plurality of dots. For example, a lookup table representing a relationship between distances among the plurality of dots and distances between the eyes and lenses (eye relief (ER) distances) may be stored in the memory 340. For example, the processor 320 may identify the first distance by using the lookup table representing a relationship between a distance among the plurality of dots and an eye relief (ER) distance.

According to an embodiment, the processor 320 may identify an area corresponding to the plurality of dots. According to an embodiment, the area corresponding to the plurality of dots may refer to an area configured by the plurality of dots. In an embodiment, the processor 320 may identify a first distance, based on the size of an area corresponding to the plurality of dots. For example, a lookup table representing a relationship between a size corresponding to the plurality of dots and an ER distance may be stored in the memory 340. For example, the processor 320 may identify the first distance by using the lookup table representing a relationship between the size corresponding to the plurality of dots and the ER distance.

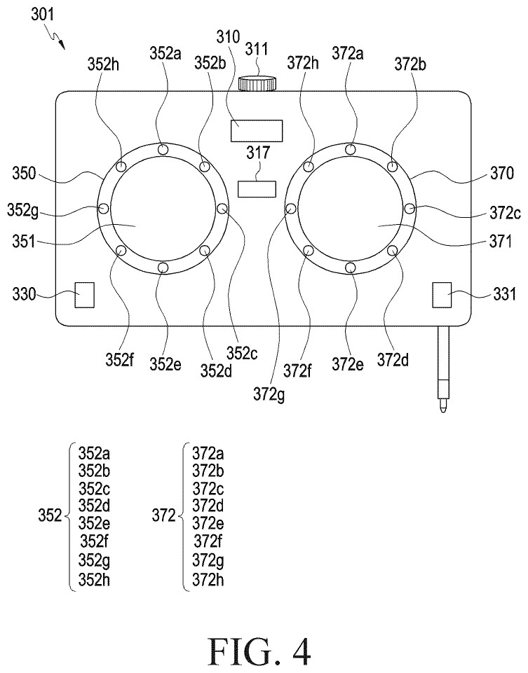

According to an embodiment, the wearable electronic device 301 may further include a depth sensor 317 (for example, the depth sensor 317 of FIG. 4). In an embodiment, the processor 320 may identify a first distance between at least one first lens 351 and one eye of a user by using the depth sensor 317 included in the wearable electronic device 301. In an embodiment, the processor 320 may transmit a signal to one eye of the user via the depth sensor 317 and identify the first distance by using a signal reflected from the one eye of the user. In an embodiment, the depth sensor 317 may be implemented identically or similarly to the depth sensor 217 of FIG. 2A.

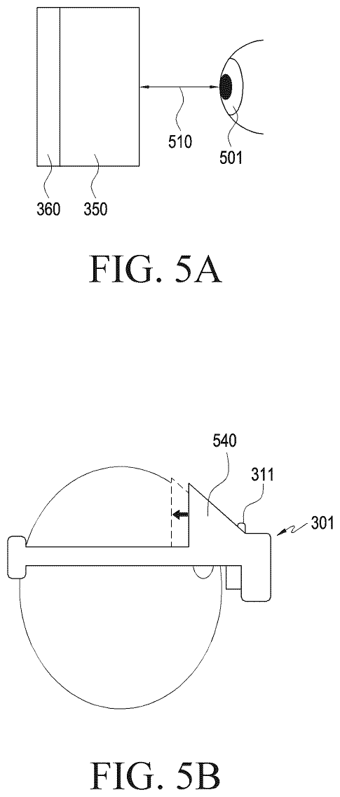

According to an embodiment, the wearable electronic device 301 may include a dial 311 (for example, the dial 311 of FIG. 4) configured to adjust a distance between the at least one first lens 351 and one eye of a user. In an embodiment, when the dial 311 is rotated, a portion 540 of the housing of the wearable electronic device 301 (for example, a portion 540 of the housing shown in FIG. 5B) may move. In an embodiment, as a portion 540 of the housing moves, the portion 540 of the housing may be brought into contact with a portion of the user's face (for example, the forehead). In an embodiment, when the dial is rotated, the portion 540 of the housing may move. In an embodiment, as the portion 540 of the housing moves, a distance between at least one first lens 351 and one eye of the user may be adjusted. In an embodiment, the processor 320 may identify the first distance between at least one first lens 351 and one eye of the user, based on the number of rotations of the dial. For example, a lookup table representing a relationship between the number of rotations of the dial and an ER distance may be stored in the memory 340. For example, the processor 320 may identify the first distance by using the lookup table representing a relationship between the number of rotations of the dial and the ER distance.

However, this is merely an example, and the embodiments described herein may identify a distance between the at least one first lens 351 and one eye of a user in various other ways.

According to an embodiment, the plurality of first pixels included in the first display 360 may output light. In an embodiment, light output from the plurality of first pixels included in the first display 360 may pass through the at least one first lens 351. In an embodiment, the luminance of the light transmitted through the at least one first lens 351 may be lower than the luminance of the light output from the plurality of first pixels. In an embodiment, the luminance of the light transmitted through the at least one first lens 351 may decrease as it moves away from a position corresponding to a third distance with respect to the center of the at least one first lens 351 toward an edge of the at least one first lens 351. For example, the third distance may refer to a position from which the luminance of the light transmitted through the at least one first lens 351 begins to decrease with respect to the center of the at least one first lens 351. For example, the third distance may refer to a distance corresponding to 0.5 times the radius of the at least one first lens 351. However, this is merely an example, and the third distance is not limited thereto.

According to an embodiment, the processor 320 may adjust the luminance of light emitted from at least one pixel among the plurality of first pixels such that the luminance of the light transmitted through the at least one first lens 351 decreases as it moves from a position corresponding to a first designated distance, which is farther than the third distance with respect to the center of the at least one first lens 351, toward an edge of the at least one first lens 351. At this time, according to an embodiment, the processor 320 may adjust the luminance of light emitted from at least one pixel among the plurality of first pixels such that a rate at which the luminance of the light transmitted through the at least one first lens 351 decreases becomes relatively smaller. For example, the processor 320 may adjust the luminance of light emitted from at least one pixel by controlling the intensity of the light emitted from the at least one pixel. For example, the first designated distance may refer to a distance corresponding to 0.8 times the radius of the at least one first lens 351. However, this is merely an example, and the first designated distance is not limited thereto. For example, the at least one pixel may refer to at least one unit pixel.

According to an embodiment, the processor 320 may adjust the luminance of light output from at least one pixel among a plurality of first pixels such that the luminance of light transmitted through the at least one first lens 351 has a constant value over the entire area of the at least one first lens 351, regardless of the distance from the center of the at least one first lens 351.

According to an embodiment, the processor 320 may adjust the luminance of light output from at least one pixel among the plurality of first pixels, based on a first distance. According to an embodiment, the processor 320 may adjust the luminance of light output from at least one pixel among the plurality of first pixels, by using a lookup table representing the relationship among the first distance, the luminance of light output from the plurality of first pixels, and a plurality of fields (F) of at least one first lens 351. According to an embodiment, the lookup table may include adjusted luminance values of light output from at least one pixel among the plurality of first pixels. According to an embodiment, the lookup table may be stored in the memory 340 or in memory included in a display driver IC (not shown).

According to an embodiment, the lookup table may be obtained based on the first distance, a luminance map based on the luminance value of light output from the first display 360, and a luminance map based on the luminance value observed after the light passes through the at least one first lens 351.

According to an embodiment, the processor 320 may acquire a luminance value of light output from the first display 360. In this case, the processor 320 may acquire a luminance value output from each of the plurality of first pixels included in the first display 360, and may acquire a first luminance map, based on the luminance values. According to an embodiment, when the distance between at least one first lens 351 and one eye of the user is a first distance, the processor 320 may acquire a luminance value observed after the light passes through the at least one first lens 351. According to an embodiment, the processor 320 may acquire a second luminance map, based on the luminance value observed after the light passes through the at least one first lens 351. According to an embodiment, the processor 320 may determine an adjustment value of the luminance of light output from at least one pixel among the plurality of first pixels to acquire a third luminance map by using the first luminance map and the second luminance map. For example, the third luminance map may refer to a luminance map in which the luminance distribution of light transmitted through the at least one first lens 351 is uniform across the entire area of the at least one first lens 351. According to an embodiment, the processor 320 may acquire a lookup table by using the first distance, the first luminance map, the second luminance map, and the third luminance map.

According to an embodiment, the plurality of fields may be defined based on the distance from the center of the at least one first lens 351. According to an embodiment, the center of the at least one first lens 351 may coincide with the center of the first display 360. Each of the plurality of fields may refer to a set of positions having the same distance from the center of the at least one first lens 351. The plurality of fields may be defined as values between 0 and 1. For example, 0F may represent the center of the at least one first lens 351. For example, 0.5F may represent a set of positions corresponding to a distance that is 0.5 times the radius of the at least one first lens 351 from the center thereof. For example, 0.8F may represent a set of positions corresponding to a distance that is 0.8 times the radius of the at least one first lens 351 from the center thereof. For example, 1F may represent a set of positions corresponding to a distance equal to the radius of the at least one first lens 351 from the center thereof.

However, this is merely an example, and the center of the at least one first lens 351 and the center of the first display 360 may not coincide. Even in this case, the plurality of fields may be defined, based on the distance from the center of the at least one first lens 351, in the same manner as when the center of the at least one first lens 351 coincides with the center of the first display 360.

According to an embodiment, the processor 320 may adjust the luminance of light by adjusting the intensity of light output from the plurality of first pixels. According to an embodiment, the processor 320 may adjust the intensity of light output from at least one pixel among the plurality of first pixels, based on the position of the plurality of pixels corresponding to the plurality of fields of the at least one first lens 351.

According to an embodiment, the processor 320 may adjust the intensity of first light output from at least one first pixel corresponding to a first designated distance from the center of the first display 360 so as to be greater than the intensity of second light output from at least one second pixel corresponding to a second designated distance, which is closer to the center of the first display 360 than the first designated distance. For example, the at least one first pixel corresponding to the first designated distance may refer to a pixel positioned at a location corresponding to 0.8F of the at least one first lens 351. For example, the at least one second pixel corresponding to the second designated distance may refer to a pixel positioned at a location corresponding to 0.5F of the at least one first lens 351.

Table 1 below shows an example of a lookup table representing the relationship among the first distance, the adjusted luminance of light output from each of the plurality of first pixels, and the plurality of fields (F) of the at least one first lens 351. However, the lookup table is not limited to the numerical values shown in Table 1 below. For example, before the processor 320 performs an operation of adjusting the luminance of light output from the first display 360, the processor 320 may output light of approximately 1250 nits via the first display 360, regardless of the field of the first display 360.

TABLE 1

| Field | Luminance (nits) | Luminance (nits) | Luminance (nits) |
|---|---|---|---|
| (F) | when ER is 12 mm | when ER is 16 mm | when ER is 20 mm |
| 0 | 1250 | 1250 | 1250 |
| 0.1 | 1250 | 1250 | 1250 |
| 0.2 | 1250 | 1250 | 1250 |
| 0.3 | 1250 | 1250 | 1250 |
| 0.4 | 1250 | 1250 | 1260 |
| 0.5 | 1250 | 1250 | 1270 |
| 0.6 | 1260 | 1280 | 1300 |
| 0.7 | 1270 | 1320 | 1380 |
| 0.8 | 1290 | 1450 | 1660 |
| 0.9 | 1290 | 1450 | 1660 |
| 1 | 1290 | 1450 | 1660 |

For example, when the first distance is 12 mm, the processor 320 may not adjust the luminance of light output from the first display 360 between 0F and approximately 0.5F. The processor 320 may increase the luminance value of light output from the first display 360 between approximately 0.5F and 1F. The processor 320 may adjust the intensity of light output from at least one pixel among a plurality of pixels arranged at positions corresponding to positions between approximately 0.8F and 1F so that the adjusted luminance value of the light is uniform between 0.8F and 1F. For example, when the first distance is 16 mm, the processor 320 may not adjust the luminance of light output from the first display 360 between 0F and approximately 0.5F. The processor 320 may increase the luminance value of light output from the first display 360 between approximately 0.5F and 1F. The processor 320 may adjust the intensity of light output from at least one pixel among a plurality of pixels arranged at positions corresponding to positions between approximately 0.8F and 1F so that the adjusted luminance value of the light is uniform between 0.8F and 1F. For example, when the first distance is 20 mm, the processor 320 may not adjust the luminance of light output from the first display 360 between 0F and approximately 0.3F. The processor 320 may increase the luminance value of light output from the first display 360 between approximately 0.3F and 1F. The processor 320 may adjust the intensity of light output from at least one pixel among a plurality of pixels arranged at positions corresponding to positions between approximately 0.8F and 1F so that the adjusted luminance value of the light is uniform between 0.8F and 1F.

Through this, after the luminance of light output from the first display 360 is adjusted, the luminance of light transmitted through the first lens 351 may decrease, in relative terms, from a field farther from the center of the at least one first lens 351, compared to the luminance of light transmitted through the first lens 351 before the luminance of light output from the first display 360 is adjusted. The rate at which the luminance of light transmitted through the first lens 351 decreases after the luminance of light output from the first display 360 is adjusted may be relatively smaller than the rate at which the luminance of light transmitted through the first lens 351 decreases before the luminance of light output from the first display 360 is adjusted. According to an embodiment, the processor 320 may adjust the luminance of light so that the luminance values of light output from a plurality of pixels arranged at positions corresponding to positions between 0.8F and 1F have a specific value and do not increase further, thereby reducing the current consumed for adjusting the luminance of light. The processor 320 may adjust the luminance distribution of light output from the first display 360 to be uniform across the plurality of fields, thereby providing a clear screen that includes a virtual object displayed via the first lens 351.

According to an embodiment, the processor 320 may include a main processor (e.g., the main processor 121 of FIG. 1) and a sub-processor (e.g., the sub-processor 123 of FIG. 1). According to an embodiment, the operation of identifying a distance between the at least one first lens 351 and one eye of the user may be performed by the sub-processor. According to an embodiment, the operation of adjusting the luminance of light output from the first display 360 may be performed by the main processor. However, this is merely an example, and the operations performed in the embodiments of the disclosure may be performed out by either the main processor or the sub-processor.

According to an embodiment, the processor 320 may identify an adjustment value of the luminance of light output from at least one pixel among the plurality of first pixels, and a field corresponding to the at least one pixel, by using the lookup table stored in the memory 340. According to an embodiment, the processor 320 may transmit the adjustment value and the field to a display driver IC (DDI). According to an embodiment, the display driver IC may adjust the intensity of light output from at least one pixel located in the corresponding field, based on the adjustment value and the field.

The operations of the wearable electronic device 301 described in the drawings below may be performed by the processor 320. However, for convenience of explanation, the operations performed by the processor 320 will be described as being performed by the wearable electronic device 301.

FIG. 4 illustrates a rear surface of a wearable electronic device according to an embodiment.

Referring to FIG. 4, according to an embodiment, a sensor 310 (e.g., the sensor 310 of FIG. 3), at least one first lens 351 (e.g., the at least one first lens 351 of FIG. 3), a plurality of first light emitting elements 352 (e.g., the plurality of first light emitting elements 352 of FIG. 3), at least one second lens 371 (e.g., the at least one second lens 371 of FIG. 3), a plurality of second light emitting elements 372 (e.g., the plurality of second light emitting elements 372 of FIG. 3), a first camera 330 (e.g., the first camera 330 of FIG. 3), and a second camera 331 (e.g., the second camera 331 of FIG. 3) may be disposed on the rear surface of the wearable electronic device 301 (e.g., the wearable electronic device 301 of FIG. 3). According to an embodiment, a dial 311 may be disposed on a housing of the wearable electronic device 301. According to an embodiment, a depth sensor 317 may further be disposed on the rear surface of the wearable electronic device 301. According to an embodiment, the sensor 310 may be implemented as a proximity sensor. According to an embodiment, the wearable electronic device 301 may identify, via the sensor 310, that the wearable electronic device 301 is worn by a user. According to an embodiment, the plurality of first light emitting elements 352 may be disposed at an edge portion of a housing of a first lens module 350) and may be exposed to the outside of the housing of the first lens module 350. According to an embodiment, the plurality of second light emitting elements 372 may be disposed at an edge portion of a housing of a second lens module 370 and may be exposed to the outside of the housing of the second lens module 370. The number and shape of the plurality of first light emitting elements 352 and the plurality of second light emitting elements 372 illustrated in FIG. 4 are merely examples and are not limited thereto.

According to an embodiment, the plurality of first light emitting elements 352 may output a plurality of invisible light to one eye of a user. According to an embodiment, the plurality of second light emitting elements 372 may output a plurality of invisible light to the other eye of the user. According to an embodiment, the plurality of invisible light may include light in an infrared (IR) band.

According to an embodiment, the wearable electronic device 301 may identify a plurality of dots on which the plurality of invisible light output from the plurality of first light emitting elements 352 are focused on one eye of the user through the first camera 330. According to an embodiment, the wearable electronic device 301 may identify a plurality of dots on which the plurality of invisible light output from the plurality of second light emitting elements 372 are focused on the other eye of the user through the second camera 331.

According to an embodiment, when the dial 311 is rotated, a distance between the at least one first lens 351 and one eye of the user, and a distance between the at least one second lens 371 and the other eye of the user, may be adjusted. According to an embodiment, the wearable electronic device 301 may identify the number of rotations of the dial 311. According to an embodiment, the wearable electronic device 301 may identify a first distance between the at least one first lens 351 and one eye of the user, based on the number of rotations of the dial 311. According to an embodiment, the wearable electronic device 301 may identify a first distance between the at least one second lens 371 and the other eye of the user, based on the number of rotations of the dial 311.

Depending on the implementation, according to an embodiment, the wearable electronic device 301 may identify a first distance between the at least one first lens 351 and one eye of the user by using the depth sensor 317. According to an embodiment, the wearable electronic device 301 may identify a first distance between the at least one second lens 371 and the other eye of the user by using the depth sensor 317.

The shapes, numbers, or arrangement states of the sensor 310, the depth sensor 317, the first lens 351, the plurality of first light emitting elements 352, the second lens 371, the plurality of second light emitting elements 372, the first camera 330, the second camera 331, and the dial 311 shown in FIG. 4 are not limited thereto. The shape of the housing of the wearable electronic device 301 shown in FIG. 4 is not limited thereto.

FIG. 5A illustrates a portion of a wearable electronic device when the wearable electronic device is worn by a user, according to an embodiment.

Referring to FIG. 5A, according to an embodiment, the wearable electronic device 301 (e.g., the wearable electronic device 301 of FIG. 3) may include a first lens module 350 (e.g., the first lens module 350 of FIG. 3) and a first display 360 (e.g., the first display 360 of FIG. 3).

According to an embodiment, the first display 360 may be disposed under the first lens module 350. However, this is merely an example, and the first display 360 and the first lens module 350 may be implemented as a single module.

According to an embodiment, the wearable electronic device 301 may identify a first distance 510 between at least one first lens 351 (e.g., the at least one first lens 351 of FIG. 3) included in the first lens module 350 and one eye 501 of a user. According to an embodiment, the first distance 510 may refer to eye relief (ER) distance between the lens and the eye. According to an embodiment, the first distance 510 may refer to a linear distance between the pupil of one eye 501 of the user and the at least one first lens 351.

FIG. 5B illustrates an operation of identifying a distance between one eye of a user and at least one first lens via a dial when the wearable electronic device is worn by the user, according to an embodiment.

Referring to FIG. 5B, according to an embodiment, when the dial 311 is rotated, a portion 540 of a housing of the wearable electronic device 301 (e.g., the wearable electronic device 301 of FIG. 3) may move. According to an embodiment, as the portion 540 of the housing moves, the portion 540 of the housing may be brought into contact with a portion of the user's face (e.g., a forehead).

According to an embodiment, the wearable electronic device 301 may identify the number of rotations of the dial 311. According to an embodiment, the wearable electronic device 301 may read, from the memory 340 (e.g., the memory 340 of FIG. 3), a lookup table representing a relationship between the number of rotations of the dial 311 and an ER distance.

According to an embodiment, the wearable electronic device 301 may identify the ER distance corresponding to the number of rotations of the dial 311 by using the lookup table.

The shape of the wearable electronic device 301 illustrated in FIG. 5B is not limited thereto and may be implemented in various shapes.

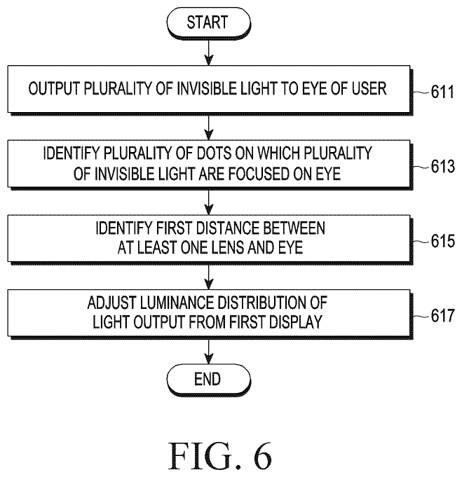

FIG. 6 is a flowchart illustrating an operation of identifying a first distance between a first lens and an eye by a wearable electronic device according to an embodiment.

Referring to FIG. 6, according to an embodiment, in operation 611, the wearable electronic device 301 (e.g., the wearable electronic device 301 of FIG. 3) may output a plurality of invisible light to one eye of a user by the plurality of first light emitting elements 352 (e.g., the plurality of first light emitting elements 352 of FIG. 3). According to an embodiment, the plurality of invisible light may include light in an infrared (IR) band.

According to an embodiment, in operation 613, the wearable electronic device 301 may identify a plurality of dots on which the plurality of invisible light are focused on one eye of the user.

According to an embodiment, in operation 615, the wearable electronic device 301 may identify a first distance between the first lens 351 and the eye, based on a pattern of the plurality of dots. For example, the pattern of the plurality of dots may refer to an arrangement state of the plurality of dots.

According to an embodiment, the wearable electronic device 301 may identify a second distance between the plurality of dots, and may identify the first distance, based on the second distance. According to an embodiment, the second distance between the plurality of dots may refer to a distance between two adjacent dots. For example, when the plurality of dots is greater than two, the second distance between the plurality of dots may include an average value of distances between adjacent dots, a minimum value among distances between adjacent dots, or a maximum value among distances between adjacent dots. According to an embodiment, the wearable electronic device 301 may identify the first distance by using the lookup table representing a relationship between the distances among the plurality of dots and the ER distances.

According to an embodiment, the wearable electronic device 301 may identify the size of an area corresponding to a plurality of dots and may identify a first distance, based on the size. According to an embodiment, the wearable electronic device 301 may identify the first distance by using a lookup table representing a relationship between the size corresponding to the plurality of dots and an ER distance.

According to an embodiment, in operation 617, the wearable electronic device 301 may adjust a luminance distribution of light output from the first display 360, based on the first distance. According to an embodiment, the wearable electronic device 301 may adjust the luminance distribution of light output from the first display 360 by adjusting the luminance of light output from at least one pixel among the plurality of first pixels included in the first display 360. According to an embodiment, the wearable electronic device 301 may adjust the luminance distribution of light output from the first display 360, by using a lookup table representing a relationship among the first distance, the luminance of light output from at least one pixel among the plurality of first pixels, and a plurality of fields (F) of the at least one first lens 351.

According to an embodiment, the plurality of fields may be defined based on a distance from the center of the at least one first lens 351. Each of the plurality of fields may refer to a set of positions having the same distance from the center of the at least one first lens 351. According to an embodiment, the lookup table may include adjusted luminance values of light output from at least one pixel among the plurality of first pixels. According to an embodiment, the lookup table may be stored in the memory 340 or in memory included in a display driver IC (not shown).

According to an embodiment, the wearable electronic device 301 may adjust the luminance of light by adjusting the intensity of light output from at least one pixel among the plurality of first pixels included in the first display 360. For example, the wearable electronic device 301 may adjust the intensity of light output from at least one pixel, based on a position of at least one pixel among the plurality of first pixels corresponding to at least one field among the plurality of fields of the at least one first lens 351.

According to an embodiment, the wearable electronic device 301 may adjust the intensity of light output from at least one first pixel corresponding to a first designated distance from the center of the first display 360 to be greater than the intensity of light output from at least one second pixel corresponding to a second designated distance (e.g., a distance corresponding to 0.5 times a radius) that is closer to the center of the first display 360 than the first designated distance (e.g., a distance corresponding to 0.8 times a radius). For example, the at least one first pixel corresponding to the first designated distance may refer to a pixel positioned at a location corresponding to 0.8F of the at least one first lens 351, and 0.8F may refer to a set of positions corresponding to a distance of 0.8 times a radius of the first lens 351 from the center of the at least one first lens 351. For example, the at least one second pixel corresponding to the second designated distance may refer to a pixel positioned at a location corresponding to 0.5F of the at least one first lens 351, and 0.5F may refer to a set of positions corresponding to a distance of 0.5 times a radius of the first lens 351 from the center of the at least one first lens 351.

According to an embodiment, when the luminance of light output from at least one pixel among the plurality of first pixels is adjusted, the luminance of light transmitted through the at least one first lens 351 may decrease as it moves from a position corresponding to a first designated distance toward an edge of the at least one first lens 351. The position corresponding to the first designated distance may be farther than a position corresponding to a third distance at which the luminance of light transmitted through the at least one first lens 351 decreases before the luminance of light is adjusted. For example, the first designated distance may refer to a distance corresponding to 0.8 times a radius of the at least one first lens 351. For example, the third distance may refer to a point at which the luminance of light transmitted through the at least one first lens 351 begins to decrease with respect to the center of the at least one first lens 351. For example, the third distance may refer to a distance corresponding to 0.5 times a radius of the at least one first lens 351. However, this is merely an example, and the first designated distance and the third distance are not limited thereto.

According to an embodiment, when the luminance distribution of light output from the first display 360 is adjusted, a rate at which the luminance of light transmitted through the at least one first lens 351 decreases may be smaller than a rate at which the luminance of light transmitted through the at least one first lens 351 decreases before the luminance distribution of light output from the first display 360 is adjusted.

According to an embodiment, the wearable electronic device 301 may provide a clear screen including a virtual object displayed via the at least one first lens 351 by adjusting the luminance distribution of light output from the first display 360 to be uniform across the plurality of fields.

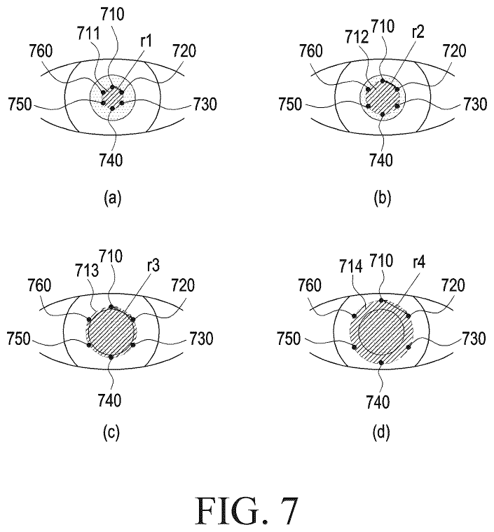

FIG. 7 illustrates an operation of identifying, based on a pattern of a plurality of dots, a distance between a lens and an eye by a wearable electronic device according to an embodiment.

Referring to FIG. 7, according to an embodiment, the wearable electronic device 301 (e.g., the wearable electronic device 301 of FIG. 3) may identify a plurality of dots 710, 720, 730, 740, 750, and 760 formed on one eye of a user by a plurality of invisible light.

According to an embodiment, the wearable electronic device 301 may identify distances r1, r2, r3, and r4 between the plurality of dots. For example, the wearable electronic device 301 may identify a distance between two adjacent dots 710 and 720 among the plurality of dots.

According to an embodiment, the wearable electronic device 301 may identify an ER distance between the first lens 351 and one eye of the user, based on the distances r1, r2, r3, r4 among the plurality of dots. According to an embodiment, the wearable electronic device 301 may identify ER by using a lookup table representing a relationship between distances among the plurality of dots and ER distances.

According to an embodiment, the wearable electronic device 301 may also identify a size 711, 712, 713, 714 corresponding to the plurality of dots. According to an embodiment, the wearable electronic device 301 may identify the first distance, based on the size 711, 712, 713, 714. According to an embodiment, the wearable electronic device 301 may identify ER by using a lookup table representing a relationship between the size corresponding to the plurality of dots and an ER distance.

According to an embodiment, the wearable electronic device 301 may identify that the smaller the distances r1, r2, r3, r4 between the plurality of dots are, the greater a distance between the at least one first lens 351 and one eye of a user is. According to an embodiment, r1 may be the smallest, r2 may be smaller than r3 and r4, and r3 may be smaller than r4. According to an embodiment, ER identified in (a) of FIG. 7 may be greater than ERs identified in (b), (c), and (d) of FIG. 7. According to an embodiment, ER identified in (b) of FIG. 7 may be greater than ERs identified in (c) and (d) of FIG. 7. According to an embodiment, ER identified in (c) of FIG. 7 may be greater than ER identified in (d) of FIG. 7.

According to an embodiment, the wearable electronic device 301 may identify that the smaller the size is, the greater a distance between the at least one first lens 351 and one eye of a user is. According to an embodiment, a first size 711 may be the smallest, a second size 712 may be smaller than third and fourth sizes 713 and 714, and the third size 713 may be smaller than the fourth size 714. According to an embodiment, the ER identified in (a) of FIG. 7 may be greater than the ERs identified in (b), (c), and (d) of FIG. 7. According to an embodiment, the ER identified in (b) of FIG. 7 may be greater than the ERs identified in (c) and (d) of FIG. 7. According to an embodiment, the ER identified in (c) of FIG. 7 may be greater than the ER identified in (d) of FIG. 7.

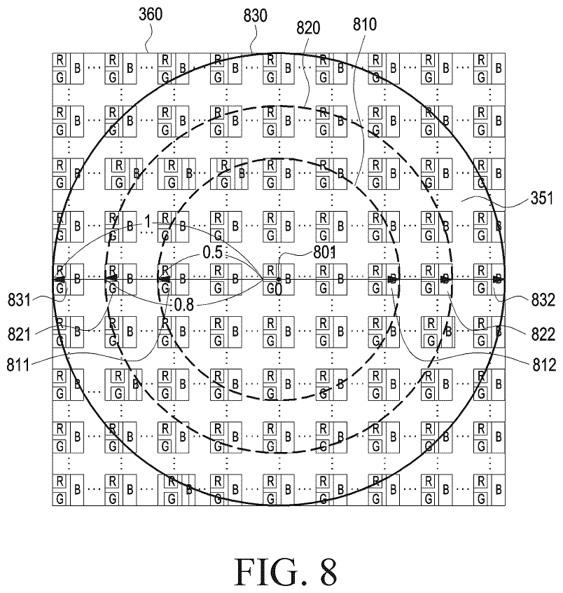

FIG. 8 illustrates at least one first lens and a first display according to an embodiment.

Referring to FIG. 8, according to an embodiment, the first display 360 (e.g., the first display 360 of FIG. 3) may be disposed under the at least one first lens 351 (e.g., the at least one first lens 351 of FIG. 3).

According to an embodiment, the first display 360 may include a plurality of first pixels. For example, the plurality of first pixels may include red (R) pixels, green (G) pixels, blue (B) pixels, and/or white (W) pixels. According to an embodiment, the plurality of first pixels may include a plurality of unit pixels. For example, one unit pixel may include an R pixel, a G pixel, and a B pixel. However, for example, a unit pixel is not limited to the unit pixels illustrated in FIG. 8 and may include R, G, B, and W pixels. However, for example, a unit pixel is not limited to the unit pixels illustrated in FIG. 8 and may include at least one pixel among R, G, B, and W pixels.

The embodiments of the disclosure are not limited to the number of pixels illustrated in FIG. 8. The dots between the plurality of pixels shown in FIG. 8 indicate that a plurality of pixels may be arranged.

According to an embodiment, the size of the first display 360 may be implemented to be larger than the size of the at least one first lens 351. According to an embodiment, the first display 360 may be implemented in a rectangular shape, and the at least one first lens 351 may be implemented in a circular shape. According to an embodiment, the center of the first display 360 may coincide with the center 801 of the at least one first lens 351. However, this is merely an example, and the size of the first display 360, the shape of the first display 360, and the shape of the first lens 351 are not limited thereto. However, this is merely an example, and the center of the first display 360 may not coincide with the center 801 of the at least one first lens 351.

According to an embodiment, the wearable electronic device 301 may adjust the luminance of light output from the first display 360, based on a first distance (e.g., an ER distance). According to an embodiment, the wearable electronic device 301 may adjust the luminance of light output from at least one pixel among the plurality of first pixels, by using a lookup table representing a relationship among the first distance, the luminance of light output from each of the plurality of first pixels, and a plurality of fields (F) of the first display 360. For example, the wearable electronic device 301 may adjust the intensity of light output from at least one pixel located in one of the plurality of fields.

According to an embodiment, the wearable electronic device 301 may adjust the luminance of light by adjusting the intensity of light output from at least one pixel among the plurality of first pixels. According to an embodiment, the wearable electronic device 301 may adjust the intensity of light output from at least one pixel, based on the position of the at least one pixel among the plurality of first pixels.

According to an embodiment, the wearable electronic device 301 may adjust the intensity of light output from at least one pixel located in each of a plurality of fields (F) of the at least one first lens 351. According to an embodiment, the plurality of fields may be defined based on a distance from a center 801 of the at least one first lens 351.

According to an embodiment, each of the plurality of fields may refer to a set of positions having the same distance from the center 801 of the at least one first lens 351. For example, 0.5F 810 may refer to a position corresponding to a distance that is 0.5 times a radius of the at least one first lens 351 from the center 801 of the at least one first lens 351. For example, 0.8F 820 may refer to a position corresponding to a distance that is 0.8 times a radius of the at least one first lens 351 from the center 801 of the at least one first lens 351. For example, 1F 830 may refer to a position corresponding to a distance that is equal to a radius of the at least one first lens 351 from the center 801 of the at least one first lens 351.

According to an embodiment, the wearable electronic device 301 may adjust the intensity of light output from at least one first pixel 821, 822, which is located at a first designated distance from a center of the at least one first lens 351, to be greater than the intensity of light output from at least one second pixel 811, 812, which is located at a second designated distance closer to the center of the at least one first lens 351 than the first designated distance. For example, the at least one first pixel corresponding to the first designated distance may refer to a pixel positioned at a location corresponding to 0.8F 820 of the at least one first lens 351. For example, the at least one second pixel 811, 812 corresponding to the second designated distance may refer to a pixel positioned at a location corresponding to 0.5F 810 of the at least one first lens 351. However, the first designated distance and the second designated distance are not limited to the above examples. According to an embodiment, the wearable electronic device 301 may control at least one third pixel 831, 832, which is located at a third designated distance, such that the intensity of light output from the at least one third pixel 831, 832 is equal to the intensity of light output from the at least one first pixel 821, 822. For example, the at least one third pixel 831 and 832 corresponding to the third designated distance may refer to a pixel positioned at a location corresponding to 1F 830 of the at least one first lens 351. However, the third designated distance is not limited to the above example.

According to an embodiment, the wearable electronic device 301 may adjust pixels arranged at positions corresponding to positions between 0.8F 820 and 1F 830 of the at least one first lens 351 to output light with the same intensity. According to an embodiment, the wearable electronic device 301 may not adjust the luminance of light output from a plurality of pixels among the plurality of first pixels that correspond to positions located at distances smaller than a second designated distance from a center of the at least one first lens 351. According to an embodiment, the wearable electronic device 301 may adjust the luminance of light output from a plurality of pixels that correspond to positions located at distances equal to or greater than the second designated distance from the center of the at least one first lens 351.

According to an embodiment, the wearable electronic device 301 may differently adjust the intensity of light output from a plurality of pixels located between the second designated distance and the first designated distance from the center of the at least one first lens 351. For example, the wearable electronic device 301 may adjust the intensity of light output from pixels located farther from the center of the at least one first lens 351 among the plurality of pixels located between the second designated distance and the first designated distance to be relatively greater. Through this, the wearable electronic device 301 may cause the luminance of light transmitted through the at least one first lens 351 to have a uniform value between the center of the at least one first lens 351 and the first designated distance.

According to an embodiment, the wearable electronic device 301 may adjust the luminance of light output from a plurality of pixels located between the first designated distance and the third designated distance from a center of the at least one first lens 351 to have the same value. Through this, a rate at which the luminance of light transmitted through the at least one first lens 351 decreases between the first designated distance and the third designated distance from the center of the at least one first lens 351 may be relatively smaller than a rate at which the luminance of light transmitted through the at least one first lens 351 decreases before the adjustment.

According to an embodiment, based on the adjustment of the luminance of light output from each of the plurality of first pixels, the wearable electronic device 301 may cause the luminance of light transmitted through the at least one first lens 351 to be uniform between the center 801 of the at least one first lens 351 and a position corresponding to the first designated distance from the center, and may cause the luminance to decrease as the distance increases from the position corresponding to the first designated distance to a position corresponding to the third designated distance.

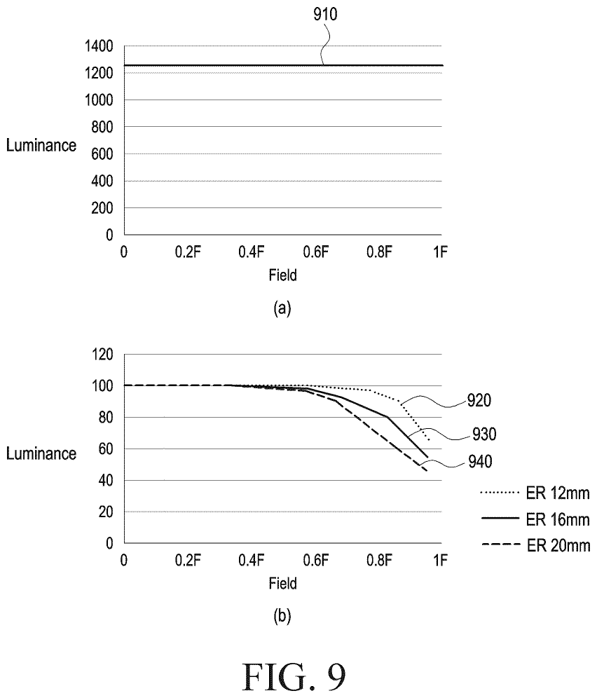

FIG. 9A to FIG. 9B illustrate graphs related to the luminance of light output from a first display and the luminance of the light transmitted through at least one first lens, when the luminance of light output from the first display is not adjusted by a wearable electronic device according to an embodiment.

Referring to FIG. 9A, the y-axis of the graph represents the luminance value of light output from the first display 360 (e.g., the first display 360 of FIG. 3), and the x-axis represents a field (F).

According to an embodiment, the wearable electronic device 301 may output, via the first display 360, light having a constant luminance value. According to an embodiment, the luminance 910 of light output from the first display 360 may remain constant regardless of the field. For example, the luminance 910 of light output from the first display 360 may be approximately 1250 nits.

Referring to FIG. 9B, the y-axis of the graph represents the luminance value of light transmitted through the at least one first lens 351, and the x-axis represents a field (F).

According to an embodiment, when the ER is 12 mm, the luminance 920 of light transmitted through the at least one first lens 351 may remain approximately 100 nits between the center 810 (e.g., 0) of the at least one first lens 351 and approximately 0.6F, and may decrease between approximately 0.6F and 1F.

According to an embodiment, when the ER is 16 mm, the luminance 930 of light transmitted through the at least one first lens 351 may remain approximately 100 nits between the center 810 of the at least one first lens 351 and about 0.5F, and may decrease between about 0.5F and 1F.

According to an embodiment, when the ER is 20 mm, the luminance 940 of light transmitted through the at least one first lens 351 may remain approximately 100 nits between the center 810 of the at least one first lens 351 and about 0.4F, and may decrease between about 0.4F and 1F.

According to an embodiment, the luminance distribution of light transmitted through the first lens 351 may be non-uniform across the plurality of fields. According to an embodiment, the wearable electronic device 301 may provide a blurred screen via the at least one first lens 351.

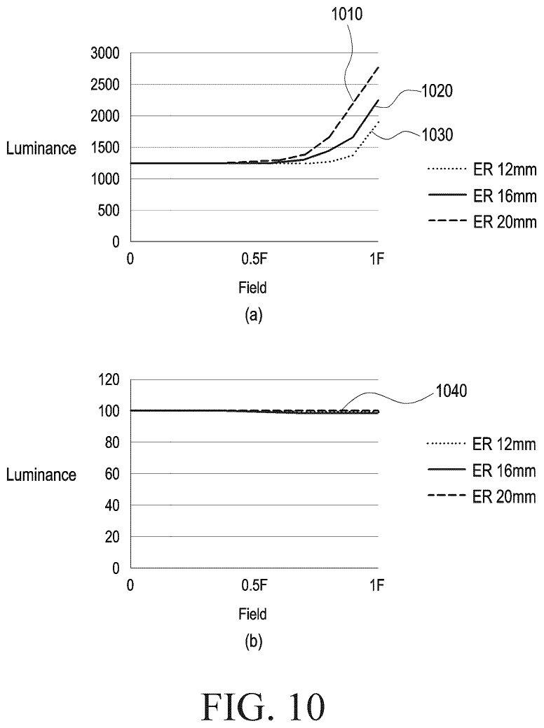

FIG. 10A to FIG. 10B illustrate a graph related to the adjusted luminance of light output from a first display and the luminance of the light transmitted through at least one first lens according to an embodiment.

Referring to FIG. 10A, the y-axis of the graph represents the luminance value of light output from the first display 360 (e.g., the first display 360 of FIG. 3), and the x-axis represents a field (F).

According to an embodiment, when the ER is 12 mm, the luminance 1030 of light output from the first display 360 may remain approximately 1250 nits between 0F and approximately 0.5F, and may increase between approximately 0.6F and 1F.

According to an embodiment, when the ER is 16 mm, the luminance 1020 of light output from the first display 360 may remain approximately 1250 nits between 0F and approximately 0.5F, and may increase between about 0.5F and 1F.

According to an embodiment, when the ER is 20 mm, the luminance 1030 of light output from the first display 360 may remain approximately 1250 nits between 0F and approximately 0.4F, and may increase between approximately 0.4F and 1F.

Referring to FIG. 10B, the y-axis of the graph represents the luminance value of light transmitted through the at least one first lens 351 (e.g., the at least one first lens 351 of FIG. 3), and the x-axis represents a field (F).

According to an embodiment, when the ERs are 12 mm, 16 mm, and 20 mm, the luminance 1040 of light transmitted through the at least one first lens 351 may remain 100 nits across the plurality of fields. The luminance distribution of light transmitted through the at least one first lens 351 may be uniform across the plurality of fields. Through this, the wearable electronic device 301 may provide a relatively enhanced visual experience to a user wearing the wearable electronic device 301 via the at least one first lens 351.

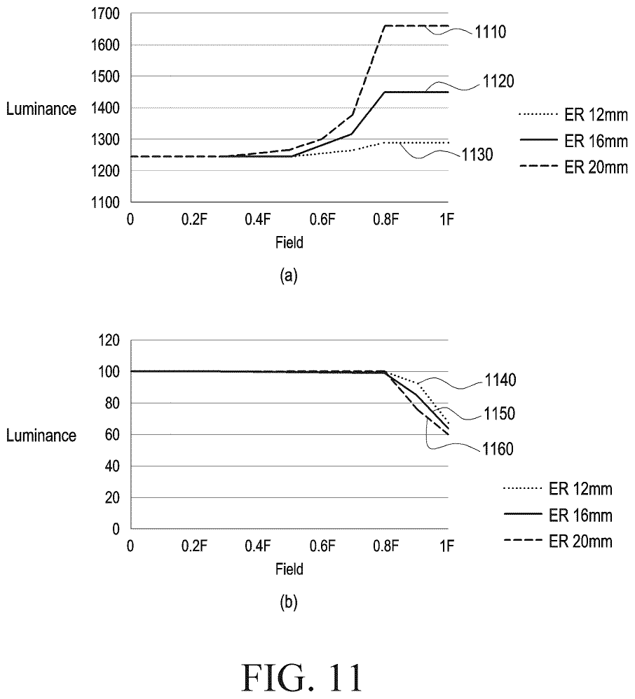

FIG. 11A to FIG. 11B illustrate graphs related to the adjusted luminance of light output from a first display and the luminance of the light transmitted through a first lens according to an embodiment.

Referring to FIG. 11A, the y-axis of the graph represents the luminance value of light output from the first display 360 (e.g., the first display 360 of FIG. 3), and the x-axis represents a field (F).

According to an embodiment, when the ER is 12 mm, the luminance 1130 of light output from the first display 360 may remain approximately 1250 nits between 0F and approximately 0.5F, and may increase between approximately 0.5F and approximately 0.8F. The luminance 1130 of light output from the first display 360 may remain constant between approximately 0.8F and 1F.

According to an embodiment, when the ER is 16 mm, the luminance 1120 of light output from the first display 360 may remain approximately 1250 nits between 0F and approximately 0.5F, and may increase between approximately 0.5F and approximately 0.8F. According to an embodiment, the luminance 1120 of light output from the first display 360 may remain constant between about 0.8F and 1F.

According to an embodiment, when the ER is 20 mm, the luminance 1110 of light output from the first display 360 may remain approximately 1250 nits between 0F and approximately 0.3F, and may increase between approximately 0.3F and approximately 0.8F. According to an embodiment, the luminance 1110 of light output from the first display 360 may remain constant between approximately 0.8F and 1F.

According to an embodiment, the wearable electronic device 301 (e.g., the wearable electronic device 301 of FIG. 3) may adjust the luminance of light output from the first display 360 such that the luminance values become relatively greater as the ER increases. For example, the luminance 1130 identified between approximately 0.8F and 1F may be 1290 nits. For example, the luminance 1120 identified between approximately 0.8F and 1F may be 1450 nits. For example, the luminance 1110 identified between approximately 0.8F and 1F may be 1660 nits.

Referring to FIG. 11B, the y-axis of the graph represents the luminance value of light transmitted through the at least one first lens 351 (e.g., the at least one first lens 351 of FIG. 3), and the x-axis represents a field (F).

According to an embodiment, when the ER is 12 mm, the luminance 1140 of light transmitted through the at least one first lens 351 may remain approximately 100 nits between 0F and approximately 0.8F, and may decrease between approximately 0.8F and 1F. According to an embodiment, the luminance 1140 of light transmitted through the at least one first lens 351 may decrease from approximately 100 nits to about 60 nits.

According to an embodiment, when the ER is 16 mm, the luminance 1150 of light transmitted through the at least one first lens 351 may remain approximately 100 nits between 0F and approximately 0.8F, and may decrease between approximately 0.8F and 1F. According to an embodiment, the luminance 1150 of light transmitted through the at least one first lens 351 may decrease from approximately 100 nits to approximately 60 nits.

According to an embodiment, when the ER is 20 mm, the luminance 1160 of light transmitted through the at least one first lens 351 may remain approximately 100 nits between 0F and approximately 0.8F, and may decrease between approximately 0.8F and 1F. According to an embodiment, the luminance 1160 of light transmitted through the at least one first lens 351 may decrease from approximately 100 nits to approximately 60 nits.

According to an embodiment, at 1F, the luminance 1140, 1150, 1160 of light transmitted through the at least one first lens 351 may be identical regardless of the ER values.

According to an embodiment, a rate at which the luminance 1140 identified between approximately 0.8F and approximately 0.9F decreases may be relatively smaller than a rate at which the luminance 1150 identified between approximately 0.8F and approximately 0.9F decreases and a rate at which the luminance 1160 identified between approximately 0.8F and approximately 0.9F decreases. According to an embodiment, a rate at which the luminance 1150 identified between approximately 0.8F and approximately 0.9F decreases may be relatively smaller than a rate at which the luminance 1160 identified between approximately 0.8F and approximately 0.9F decreases.

According to an embodiment, a rate at which the luminance 1160 identified between approximately 0.9F and 1F decreases may be relatively smaller than a rate at which the luminance 1150 identified between approximately 0.9F and 1F decreases and a rate at which the luminance 1140 identified between approximately 0.9F and 1F decreases. According to an embodiment, a rate at which the luminance 1150 identified between approximately 0.9F and 1F decreases may be relatively smaller than a rate at which the luminance 1140 identified between approximately 0.9F and 1F decreases.

According to an embodiment, a rate at which the luminance 1140 of light transmitted through the at least one first lens 351 decreases may be relatively smaller than a rate at which the luminance 920 (e.g., the luminance 920 of FIG. 9) of light transmitted through the at least one first lens 351 decreases. A luminance distribution 1140 of light transmitted through the at least one first lens 351 may be relatively more uniform than a luminance distribution 920 of light transmitted through the at least one first lens 351.

According to an embodiment, since the luminance 1130 of light output from the first display 360 remains constant between approximately 0.8F and 1F, a current consumed to output the luminance 1130 may be relatively smaller than a current consumed to output the luminance 1030 (e.g., the luminance 1030 of FIG. 10).

According to an embodiment, the wearable electronic device 301 may include a camera 330, 331, a display 360, 380 including a plurality of pixels, a lens module 350, 370 including at least one lens 351, 371 and a plurality of light emitting elements 352, 372, a processor 320, and memory 340 configured to store instructions.

According to an embodiment, when the wearable electronic device 301 is worn by a user, the wearable electronic device 301 may output a plurality of invisible light to the eye of the user via the plurality of light emitting elements 352, 372.

According to an embodiment, the wearable electronic device 301 may identify a plurality of dots on which the plurality of invisible light are focused on the eye through the camera 330, 331.

According to an embodiment, the wearable electronic device 301 may identify a first distance between the at least one lens 351, 371 and the eye, based on a pattern of the plurality of dots.

According to an embodiment, the wearable electronic device 301 may adjust luminance of light output from each of the plurality of pixels, based on the first distance.

According to an embodiment, the wearable electronic device 301 may identify a distance between the plurality of dots.

According to an embodiment, the wearable electronic device 301 may identify the first distance, based on the distance.

According to an embodiment, the wearable electronic device 301 may identify the size of an area corresponding to the plurality of dots.

According to an embodiment, the wearable electronic device 301 may identify the first distance, based on the size.

According to an embodiment, the wearable electronic device 301 may adjust the luminance of light output from the plurality of pixels, by using a lookup table representing a relationship between the first distance and the luminance of light output from each of the plurality of pixels.

According to an embodiment, the plurality of light emitting elements 352, 372 of the wearable electronic device 301 may be disposed at an edge portion of a housing of the lens module 350, 370 and may be exposed to the outside of the housing.

According to an embodiment, the wearable electronic device 301 may adjust the intensity of light output from the plurality of pixels, based on the position of the plurality of pixels.

According to an embodiment, the wearable electronic device 301 may adjust intensity of first light output from at least one first pixel corresponding to a first designated distance from a center of the display 360, 380 to be greater than intensity of second light output from at least one second pixel corresponding to a second designated distance that is closer to the center than the first designated distance, the at least one first pixel and the at least one second pixel being from among the plurality of pixels.

According to an embodiment, the wearable electronic device 301 may identify via a sensor 310 included in the wearable electronic device 301 that the wearable electronic device 301 is worn by the user.

According to an embodiment, in the wearable electronic device 301, the at least one lens 351, 371 may include a pancake lens.

According to an embodiment, the wearable electronic device 301 may include a depth sensor 317. According to an embodiment, the wearable electronic device 301 may identify the first distance, based on a sensing value sensed via the depth sensor.

According to an embodiment, a method of operating the wearable electronic device 301 may include, when the wearable electronic device 301 is worn by a user, the wearable electronic device 301, outputting a plurality of invisible light to the eye of the user via the plurality of light emitting elements 352, 372.

According to an embodiment, the method of operating the wearable electronic device 301 may include identifying, a plurality of dots on which the plurality of invisible light are focused on the eye through the camera 330, 331.

According to an embodiment, the method of operating the wearable electronic device 301 may include identifying a first distance between the at least one lens 351, 371 and the eye, based on a pattern of the plurality of dots.

According to an embodiment, the method of operating the wearable electronic device 301 may include adjusting luminance of light output from each of the plurality of pixels, based on the first distance.

According to an embodiment, the method of operating the wearable electronic device 301 may include identifying a distance between the plurality of dots.

According to an embodiment, the method of operating the wearable electronic device 301 may include identifying the first distance, based on the distance.

According to an embodiment, the method of operating the wearable electronic device 301 may include identifying the size of an area corresponding to the plurality of dots.

According to an embodiment, the method of operating the wearable electronic device 301 may include identifying the first distance, based on the size.

According to an embodiment, the method of operating the wearable electronic device 301 may include adjusting the luminance of light output from the plurality of pixels, by using a lookup table representing a relationship between the first distance and the luminance of light output from each of the plurality of pixels.

According to an embodiment, in the method of operating the wearable electronic device 301, the plurality of light emitting elements may be disposed at an edge portion of a housing of the lens module 350, 370 and may be exposed to the outside of the housing.

According to an embodiment, the method of operating the wearable electronic device 301 may include adjusting the intensity of light output from the plurality of pixels, based on the position of the plurality of pixels.

According to an embodiment, the method of operating the wearable electronic device 301 may include adjusting intensity of first light output from at least one first pixel corresponding to a first designated distance from a center of the display 360, 380 to be greater than intensity of second light output from at least one second pixel corresponding to a second designated distance that is closer to the center than the first designated distance, the at least one first pixel and the at least one second pixel being from among the plurality of pixels.

According to an embodiment, the method of operating the wearable electronic device 301 may include identifying via a sensor 310 included in the wearable electronic device 301 that the wearable electronic device 301 is worn by the user.

According to an embodiment, in the method of operating the wearable electronic device 301, the at least one lens 351, 371 may include a pancake lens.

According to an embodiment, a non-transitory recording medium may store at least one instruction that, when executed, causes the wearable electronic device to, when the wearable electronic device is worn by a user, output a plurality of invisible light to the eye of the user via the plurality of light emitting elements 352, 372.

According to an embodiment, the non-transitory recording medium may store at least one instruction that, when executed, causes the wearable electronic device to identify a plurality of dots on which the plurality of invisible light are focused on the eye through the camera 330, 331.

According to an embodiment, the non-transitory recording medium may store at least one instruction that, when executed, causes the wearable electronic device to identify a first distance between the at least one lens 351, 371 and the eye, based on a pattern of the plurality of dots.

According to an embodiment, the non-transitory recording medium may store at least one instruction that, when executed, causes the wearable electronic device to adjust luminance of light output from the plurality of pixels, based on the first distance.

According to an embodiment, the non-transitory recording medium may store at least one instruction that, when executed, causes the wearable electronic device to identify a distance between the plurality of dots.

According to an embodiment, the non-transitory recording medium may store at least one instruction that, when executed, causes the wearable electronic device to identify the first distance, based on the distance.

According to an embodiment, the non-transitory recording medium may store at least one instruction that, when executed, causes the wearable electronic device to identify the size of an area corresponding to the plurality of dots.

According to an embodiment, the non-transitory recording medium may store at least one instruction that, when executed, causes the wearable electronic device to identify the first distance, based on the size.

According to an embodiment, the non-transitory recording medium may store at least one instruction that, when executed, causes the wearable electronic device to adjust the luminance of light output from the plurality of pixels, by using a lookup table representing a relationship between the first distance and the luminance of light output from the plurality of pixels.

According to an embodiment, in the non-transitory recording medium, the plurality of light emitting elements 352, 372 of the wearable electronic device may be disposed at an edge portion of a housing of the lens module 350, 370 and may be exposed to the outside of the housing.

According to an embodiment, the non-transitory recording medium may store at least one instruction that, when executed, causes the wearable electronic device to adjust the intensity of light output from the plurality of pixels, based on the position of the plurality of pixels.

According to an embodiment, the non-transitory recording medium may store at least one instruction that, when executed, causes the wearable electronic device to adjust intensity of first light output from at least one first pixel corresponding to a first designated distance from a center of the display 360, 380 to be greater than intensity of second light output from at least one second pixel corresponding to a second designated distance that is closer to the center than the first designated distance, the at least one first pixel and the at least one second pixel being from among the plurality of pixels.

According to an embodiment, the non-transitory recording medium may store at least one instruction that, when executed, causes the wearable electronic device to identify via a sensor 310 included in the wearable electronic device 301 that the wearable electronic device 301 is worn by the user.

According to an embodiment, in the non-transitory recording medium, the at least one lens 351, 371 may include a pancake lens.

The technical problems to be achieved by the disclosure are not limited to those described above, and other technical problems not mentioned herein will be clearly understood by those skilled in the art to which the disclosure pertains.

The effects that can be obtained from the disclosure are not limited to the effects described above, and other effects not mentioned herein will be clearly understood by those skilled in the art to which the disclosure pertains.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101, 201, 301). For example, a processor (e.g., the processor 120, 320) of the machine (e.g., the electronic device 101, 201, 301) may invoke at least one of the one or more instructions stored in the storage medium, and execute it, with or without using one or more other components under the control of the processor. Each “processor” herein comprises processing circuitry and may comprise one or more processors. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A wearable electronic device comprising:
a camera;
a display comprising a plurality of pixels;
a lens module comprising at least one lens and a plurality of light emitting elements;
at least one processor comprising processing circuitry; and
memory storing instructions,
wherein the instructions, when executed by the at least one processor individually and/or collectively, cause the wearable electronic device to:
when identifying that the wearable electronic device is worn by a user, output a plurality of invisible light to the user's eye via the plurality of light emitting elements;
identify a plurality of dots on which the plurality of invisible light are focused on the user's eye via the camera;
based on a pattern of the plurality of dots, identify a first distance between the at least one lens and the user's eye; and
based on the first distance and a position of the plurality of pixels, adjust luminance of light output from the plurality of pixels.

2. The wearable electronic device of claim 1, wherein the instructions, when executed by the at least one processor individually and/or collectively, cause the wearable electronic device to:
identify a second distance between the plurality of dots; and
based on the second distance, identify the first distance.

3. The wearable electronic device of claim 1,
wherein the instructions, when executed by the at least one processor individually and/or collectively, cause the wearable electronic device to:
identify a size of an area corresponding to the plurality of dots; and
based on the size, identify the first distance.

4. The wearable electronic device of claim 1,
wherein the instructions, when executed by the at least one processor individually and/or collectively, cause the wearable electronic device to:
adjust the luminance of the light output from the plurality of pixels using a lookup table representing a relationship between the first distance and the luminance of the light output from the plurality of pixels.

5. The wearable electronic device of claim 1,
wherein the plurality of light emitting elements is disposed proximate an edge portion of a housing of the lens module and visible from outside of the housing.

6. The wearable electronic device of claim 1,
wherein the instructions, when executed by the at least one processor individually and/or collectively, cause the wearable electronic device to:
adjust an intensity of the light output from the plurality of pixels based on the position of the plurality of pixels.

7. The wearable electronic device of claim 6,
wherein the instructions, when executed by at least one processor individually and/or collectively, cause the wearable electronic device to:
adjust an intensity of first light, which is output from at least one first pixel corresponding to a first designated distance from a center of the display among the plurality of pixels, to be greater than an intensity of second light, which is output from at least one second pixel corresponding to a second designated distance closer than the first designated distance from the center.

8. The wearable electronic device of claim 1, further comprising:
a sensor, and
wherein the instructions, when executed by the at least one processor individually and/or collectively, cause the wearable electronic device to:
identify that the wearable electronic device is worn by the user via the sensor included in the wearable electronic device.

9. The wearable electronic device of claim 1,
wherein the at least one lens includes a pancake lens.

10. The wearable electronic device of claim 1, further comprising:
a depth sensor, and wherein the instructions, when executed by the at least one processor individually and/or collectively, cause the wearable electronic device to:
identify the first distance, based on sensing value sensed via the depth sensor.

11. A method of operating a wearable electronic device comprising a camera, a display comprising a plurality of pixels, and a lens module comprising at least one lens and a plurality of light emitting elements,
wherein the method comprises:
identifying that the wearable electronic device is to be worn by a user, and based thereon outputting a plurality of invisible light to the user's eye via the plurality of light emitting elements;
identifying, via the camera, a plurality of dots on which the plurality of invisible light are focused on the user's eye;
based on a pattern of the plurality of dots, identifying a first distance between the at least one lens and the user's eye; and
based on the first distance and a position of the plurality of pixels, adjusting luminance of light output from the plurality of pixels.

12. The method of claim 11, wherein the identifying of the first distance between the at least one lens and the eye comprises:
identifying a second distance between the plurality of dots; and
based on the second distance, identifying the first distance.

13. The method of claim 11, wherein the identifying of the first distance between the at least one lens and the eye comprises:
identifying a size of an area corresponding to the plurality of dots; and
based on the size, identifying the first distance.

14. The method of claim 11, wherein the adjusting of the luminance of light output from the plurality of pixels comprises adjusting the luminance of light output from the plurality of pixels using a lookup table representing a relationship between the first distance and the luminance of the light output from the plurality of pixels.

15. A non-transitory recording medium storing at least one instruction that, when executed, causes a wearable electronic device, which comprises a camera, a display comprising a plurality of pixels, and a lens module comprising at least one lens and a plurality of light emitting elements, to:
in a case that the wearable electronic device is identified to be worn by a user, output a plurality of invisible light to the user's eye via the plurality of light emitting elements;
identify, via the camera, a plurality of dots on which the plurality of invisible light are focused on the user's eye;
based on a pattern of the plurality of dots, identify a first distance between the at least one lens and the user's eye; and
based on the first distance and a position of the plurality of pixels, adjust luminance of light output from the plurality of pixels.
